(19) United States
(12) Patent Application Publication
(10) Pub. No.: US 2025/0058638 A1
(43) Pub. Date: Feb. 20, 2025

(54) HYDROGEN FUEL CELL POWERED AUTONOMOUS UNDERWATER VEHICLE

(71) Applicant: CELLULA ROBOTICS, LTD., Burnaby (CA)

(72) Inventors: James Eric Jackson, Vancouver (CA); Reuben Meikle, Vancouver (CA); Chris Kaminski, Vancouver (CA); Orrin Malacko, Vancouver (CA)

(21) Appl. No.: 18/807,272

(22) Filed: Aug. 16, 2024

Related U.S. Application Data
(60) Provisional application No. 63/533,491, filed on Aug. 18, 2023.

(51) Int. Cl. B60L 3/00; B60L 58/32; B63G 8/00; H01M 8/04007; H01M 8/04119; H01M 8/0444; H01M 8/04858; H01M 8/04955; H01M 8/10

(52) U.S. Cl. CPC B60L 3/0053; B60L 58/32; B63G 8/001; H01M 8/04067; H01M 8/04156; H01M 8/04447; H01M 8/04455; H01M 8/04925; H01M 8/04955; B60L 2250/00; B63G 2008/004; H01M 2008/1095; H01M 2250/20

(57) ABSTRACT

An autonomous underwater vehicle (AUV) including a hydrogen fuel cell is provided. The fuel cell control computer is a separate, stand-alone control system that interfaces with a vehicle control computer (VCC) to ensure safe operation of the fuel cell system. Relay logic for disabling the fuel cell enables the VCC to determine if the fuel cell has shut down, ensuring that the AUV system does not send power to the fuel cell system if there are unsafe conditions.

### CROSS REFERENCE TO RELATED APPLICATION

The present application claims the benefit of and priority, under 35 U.S.C. § 119 (e), to U.S. Provisional Application Ser. No. 63/533,491, filed on Aug. 18, 2023, entitled “HYDROGEN FUEL CELL POWERED AUTONOMOUS UNDERWATER VEHICLE.” The entire disclosure of the application listed above is hereby incorporated by reference, in its entirety, for all that it teaches and for all purposes.

### FIELD

Example embodiments relate to fuel cell modules for use with underwater vehicles.

### BACKGROUND

Autonomous underwater vehicles (AUVs) may perform a variety of missions, such as underwater mapping surveys, vessel characterization, and the like. The AUV may in some cases include a power source (e.g., an on-board battery) that powers one or more components or modules of the AUV. In other cases, the AUV may be coupled with a power source separate from the AUV that provides power to one or more components of the AUV.

### BRIEF DESCRIPTION OF THE DRAWINGS

The present disclosure is described in conjunction with the appended figures, which are not necessarily drawn to scale:

FIG. 1 shows a block diagram of a system in accordance with embodiments of the present disclosure.

FIG. 2 is a block diagram of aspects of a fuel cell module in accordance with embodiments of the present disclosure.

FIG. 3 is a block diagram of aspects of a fuel cell canister (FCC) in accordance with embodiments of the present disclosure.

FIG. 4A is a diagram of aspects of power logic of the FCC in accordance with embodiments of the present disclosure.

FIG. 4B is a schematic of the power logic of the FCC in accordance with embodiments of the present disclosure.

FIG. 4C is a state diagram of the fuel cell power logic in accordance with embodiments of the present disclosure.

FIG. 5 is a flowchart in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

It will be appreciated from the following description, and for reasons of computational efficiency, that the components of the system can be arranged at any appropriate location within a distributed network of components without impacting the operation of the system.

Furthermore, it should be appreciated that the various links connecting the elements can be wired, traces, optical, or wireless links, or any appropriate combination thereof, or any other appropriate known or later developed element(s) that is capable of supplying and/or communicating data to and from the connected elements. Transmission media used as links, for example, can be any appropriate carrier for electrical signals, including coaxial cables, copper wire and fiber optics, electrical traces on a PCB, and/or the like.

Various aspects of the present disclosure will be described herein with reference to drawings that may be schematic illustrations of idealized configurations.

Unless otherwise defined, all terms (including technical and scientific terms) used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and this disclosure.

In some example embodiments, an AUV may be coupled with one or more fuel cell modules that provide power to the AUV by, for example, charging power source(s) (e.g., batteries) on the AUV and/or by directly providing power to one or more subsystems of the AUV. The fuel cell may include a fuel cell control computer (FCCC) that is a separate, stand-alone system. The FCCC may interface with a vehicle control computer (VCC) in the AUV to ensure safe operation of the fuel cell system. The fuel cell module(s) may comprise a fuel cell canister (FCC) that generates power. The FCC itself may contain the FCCC, a proton exchange membrane, a cathode, an anode, pumps to move wastewater and cooling water, and hydrogen scrubbers to react excess hydrogen into water. Different types of hydrogen fuel cells may be used, such as an air breathing fuel cell or a direct oxygen fuel cell. The wastewater may be pumped into external wastewater tanks so that the overall weight of the fuel cell module remains constant.

In some examples, the fuel cell module may comprise hydrogen and oxygen reactant storage and heat exchangers that use surrounding ocean water to cool the coolant used to cool the fuel cell. The fuel cell may be operated automatically or manually and may be automatically disabled before H₂ and O₂ concentrations reach a threshold value to ensure safety and prevent explosions.

In some examples, the relay logic for shutting down or otherwise disabling the fuel cell may enable the VCC to determine if the fuel cell has shut down, ensuring that the AUV system does not send power to the fuel cell system if there are unsafe conditions. The data interface between the fuel cell module and the VCC provides data that the VCC can use to plan or replan AUV missions. The VCC can also use the data interface to command the fuel cell module to turn off and on and/or to change an operation mode of the fuel cell, depending on safety parameters and/or mission objectives.

Inventive concepts will now be further described with reference to the figures.

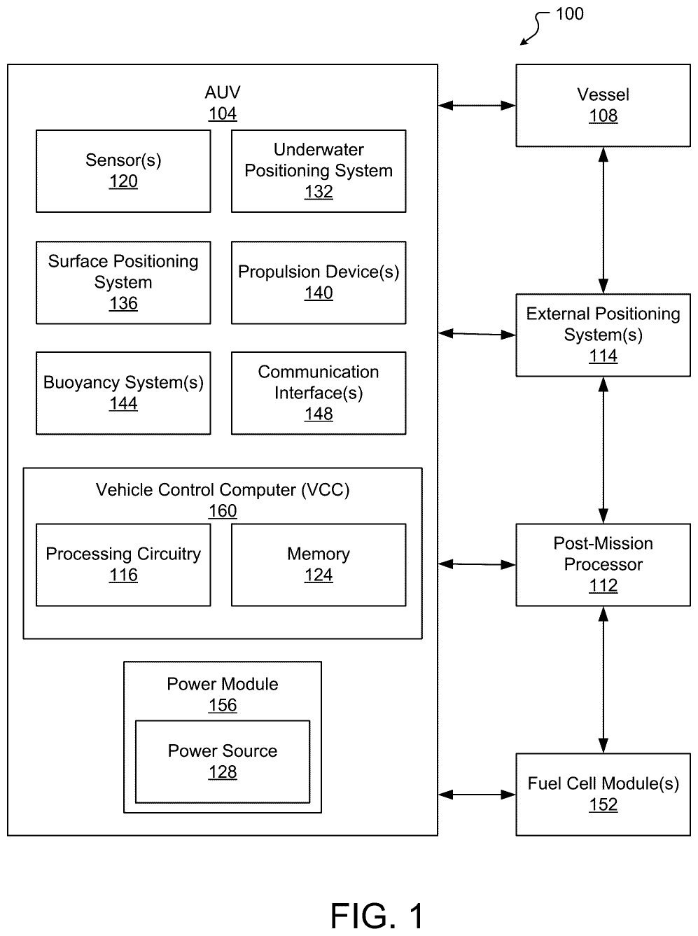

FIG. 1 illustrates a block diagram of a system 100 according to at least one example embodiment. The system 100 includes an Autonomous Underwater Vehicle (AUV) 104, a vessel 108, a post-mission processor 112, external positioning system(s) 114, and fuel cell module(s) 152. As indicated by the two-way arrows, these elements of the system 100 may be in wired and/or wireless communication with one another, although not necessarily at all times. Stated another way, an element may lose the ability to communicate (or have the ability to communicate limited) with another element at certain points during one or more missions performed by the AUV 104. For example, when the AUV 104 is at or above the surface of the water, the AUV 104 is able to communicate with the external positioning system 114 (e.g., embodied as a GPS satellite) but loses the ability to communicate with the external positioning system 114 when the AUV 104 is submerged below the water's surface. In another example, the fuel cell module 152 may be temporarily coupled with the AUV 104 to charge a power source 128 of the AUV 104 but may be disconnected when the AUV 104 performs one or more steps of a planned mission.

In general, the AUV 104 includes sensor(s) 120, underwater positioning system(s) 132, surface positioning system(s) 136, propulsion device(s) 140, buoyancy system(s) 144, communication interface(s) 148, a power module 156 that includes the power source 128, an a Vehicle Control Computer (VCC) 160 that includes processing circuitry 116 and memory 124, all of which are discussed in more detail below with reference to FIG. 1 and the remaining figures. In at least one example embodiment, the AUV 104 is a remotely operated vehicle (ROV) that is controllable (wired or wirelessly) remotely by an operator instead of or in addition to being autonomously controlled.

The vessel 108 may correspond to a surface vessel, such as a naval ship, commercial liner, or other marine vessel suited for above surface marine travel. In some examples, the vessel 108 corresponds to a subsurface marine vessel, such as a submarine or other vessel suitable for subsea travel. The vessel 108 may comprise the same or similar components as those illustrated for the AUV 104 and discussed in more detail below.

The post-mission processor 112 may comprise suitable hardware and/or software for processing sensor data from an AUV 104 for the sake of generating information related to one or more missions (e.g., underwater surveys, vessel characterization, etc.) conducted by the AUV 104. The post-mission processor 112 may comprise processing circuitry having the same or similar structure as the processing circuitry 116 of the AUV 104 discussed below. In some examples, the post-mission processor 112 comprises a graphical user interface (GUI), such as a display, that enables user interaction to sift through sensor data and display of outputs relevant to the mission performed by the AUV 104. One non-limiting example of the post-mission processor 112 is a personal computer, such as a laptop, executing one or more software applications for processing data gathered by the AUV 104.

The external positioning system(s) 114 may comprise a satellite-based system, such as an GNSS, or other suitable system for determining positions of the AUV 104 and/or the vessel 108. As such, the external positioning system(s) 114 may be remotely located from the AUV 104 and the vessel 108.

Various components of the AUV 104 will now be discussed, beginning with the VCC 160 that includes the processing circuitry 116 and memory 124. The processing circuitry 116 includes suitable components for carrying out AUV component control, AUV navigation, and the various other computer-related or computer-controlled tasks described herein, as well as for carrying out the functionality of the VCC 160 described herein. Such processing circuitry 116 may comprise software, hardware, or a combination thereof. The processing circuitry 116 may be coupled to memory 124 that includes executable instructions. In this case, the processing circuitry 116 may comprise a processor (e.g., a microprocessor) that executes the instructions on the memory 124. The memory 124 may correspond to any suitable type of memory device or collection of memory devices configured to store instructions and/or other data (e.g., sensor data generated by the sensors 120). Non-limiting examples of suitable memory devices that may be used include flash memory, Random Access Memory (RAM), Read Only Memory (ROM), variants thereof, combinations thereof, and/or the like. In some embodiments, the memory 124 and the processor may be integrated into a common device (e.g., a microprocessor may include integrated memory 124). Additionally or alternatively, the processing circuitry 116 may comprise hardware, such as an application specific integrated circuit (ASIC). Other non-limiting examples of the processing circuitry 116 include an Integrated Circuit (IC) chip, a Central Processing Unit (CPU), a Graphics Processing Unit (GPU), a microprocessor, a Field Programmable Gate Array (FPGA), a collection of logic gates or transistors, resistors, capacitors, inductors, diodes, and/or the like. Some or all of the processing circuitry 116 may be provided on a Printed Circuit Board (PCB) or collection of PCBs. It should be appreciated that any appropriate type of electrical component or collection of electrical components may be suitable for inclusion in the processing circuitry 116.

The sensor(s) 120 may comprise one or more sensors suitable for sensing parameters that are relevant to the one or more missions performed by the AUV 104, such as a magnetometer, optical sensors, electric field sensors, conductivity sensors, oxygen sensors, depth sensors, sonar, cameras, and/or the like. The sensors 120 may further include sensors for general operation of the AUV 104 in an underwater environment. For example, the sensors 120 may comprise an accelerometer and/or a gyroscope for determining AUV 104 orientation, a temperature sensor, a water quality sensor, a light sensor, a power sensor, and/or the like.

The underwater positioning system 132 may comprise suitable hardware and/or software for determining an underwater position of the AUV 104, for example, relative to the vessel 108 and/or relative to other AUVs 104. Nonlimiting examples of the underwater positioning system 132 include a high precision Inertial Navigation System (INS), a Doppler Velocity Log (DVL), and/or an acoustic system such as an ultrashort baseline (USBL) acoustic system or a long baseline (LBL) acoustic system.

The surface positioning system(s) 136 may comprise suitable hardware and/or software for determining and/or tracking a surface position of the AUV 104 (e.g., a position of the AUV 104 when the AUV 104 is at or above the water's surface). Non-limiting examples of a surface positioning system 136 include a GNSS or other satellite-based system that provides positioning, navigation, and/or timing services for the AUV 104. In at least one embodiment, the surface positioning system 136 determines a surface position of the AUV 104 relative to a position of the vessel 108 and/or relative to a position of another AUV 104 (or relative to multiple AUVs 104).

The propulsion device(s) 140 may include suitable hardware and/or software for causing underwater movements of the AUV 104. The propulsion device(s) 140 may include one or more motors (e.g., electric motors) with associated propeller(s) or thruster(s) or jets, as well as fixed and/or pivoting fins to control pitch, roll, and yaw of the AUV 104.

The buoyancy system(s) 144 may comprise suitable components for controlling the buoyancy of the AUV 104. For example, the AUV 104 may include a variable buoyancy system (VBS) that helps control AUV depth.

Communication interface(s) 148 may include suitable hardware and/or software for enabling wired and/or wireless communication between components of the AUV 104 and between the AUV 104 and the vessel 108, post-mission processor 112, and/or the external positioning system(s) 114. For example, the communication interface(s) 148 may include interfaces for acoustic serial communication (e.g., a peripheral component interconnect express (PCIe) bus), acoustic communication, blue light communication, Ethernet communication, Wi-Fi communication, cellular communication, BLUETOOTH communication, satellite communication, universal serial bus (USB) communication, and/or the like.

The power module 156 may comprise hardware and/or software components suitable for carrying out one or more functions of the power module 156 as described herein. The power module 156 may regulate, monitor, and/or otherwise control power flow through the AUV 104 and/or one or more components thereof. The power module 156 is illustrated in FIG. 1 to comprise the power source 128. However, the power module 156 may comprise additional and/or alternative components than those depicted in FIG. 1. The power source 128 may comprise hardware and/or software for powering the other illustrated and non-illustrated components of the AUV 104. In at least one example, the power source 128 comprises a battery, such as a rechargeable battery or other subsea battery. The power source 128 may comprise a fuel cell (e.g., a hydrogen fuel cell) or other fueled power source, and/or may be electrically connected to and/or in communication with the fuel cell module 152.

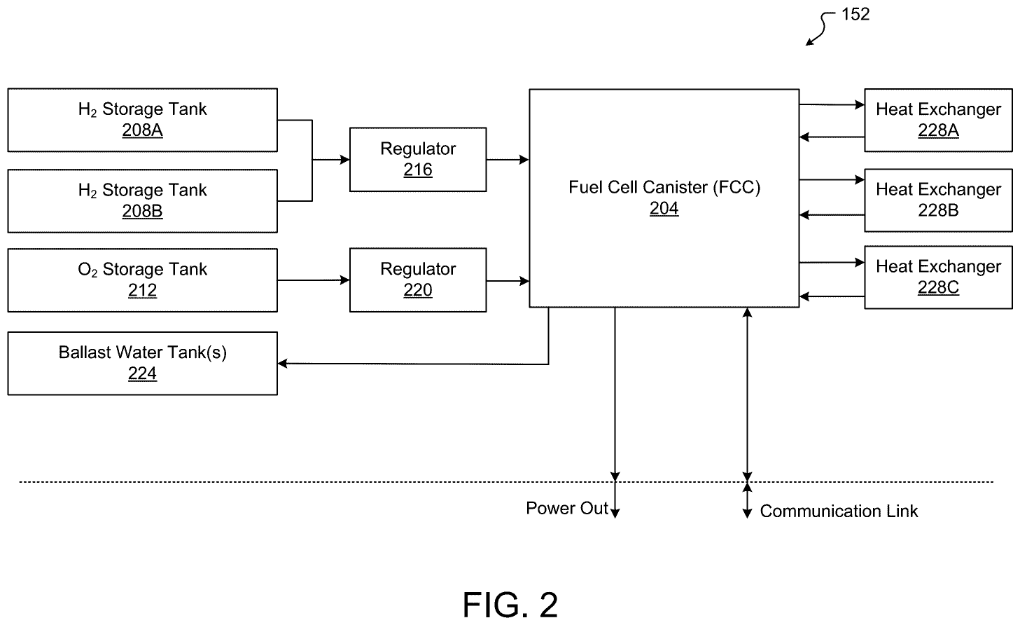

FIG. 2 is a block diagram of the fuel cell module 152 according to at least one example embodiment. The fuel cell module 152 is illustrated to comprise a fuel cell canister (FCC) 204, H₂ storage tanks 208A, 208B, O₂ storage tank 212, regulators 216, 220, ballast water tank(s) 224, and heat exchangers 228A-228C. It is to be understood that, in some examples, the fuel cell module 152 may comprise additional or alternative components than those illustrated in FIG. 2.

One or more components of the fuel cell module 152 may be attached to rigid frame(s) that provide structural integrity for the fuel cell module 152. The rigid frame(s) may enable the fuel cell module 152 to be attached to the AUV 104, may enable the fuel cell module 152 to be transported and tested (e.g., in water) as an integrated unit, and may provide one or more mounting points to which hydrodynamically smooth panels can be attached (e.g., such that the fuel cell module 152 has a hydrodynamically smooth exterior surface). Additionally or alternatively, the fuel cell module 152 may comprise ballast (e.g., lead weights) mounted to the structural frame to ensure the fuel cell module 152 is neutrally buoyant and has a level static trim while in the water.

The FCC 204 may comprise one or more components suitable for performing electrochemical reactions to generate power. For example, the FCC 204 may comprise fuel cells that generate electricity using hydrogen and oxygen. In some cases, the FCC 204 may be capable of communicating with and/or outputting power to one or more components of the fuel cell module 152 and/or one or more components of the AUV 104 (e.g., the power source 128), as discussed in further detail herein. In one example, the operation of the FCC 204 may be automatically interruptible by an operator of the AUV 104 (e.g., a human pilot) to disable fuel production in the FCC 204. For example, the operator may be able to automatically discontinue fuel production in the fuel cell module 152 when the AUV 104 is floating above the water's surface or out of water (e.g., in a repair shop, on a dock before deployment, etc.).

The H₂ storage tank 208A and the H₂ storage tank 208B may be or comprise containers suitable for storing hydrogen (H₂), and the O₂ storage tank 212 may be or comprise container(s) suitable for storing oxygen (O₂). In some cases, hydrogen and oxygen may be stored in 2:1 ratio of hydrogen to oxygen (e.g., by moles) for the purposes of generating electricity through electrochemical reaction of the two. In one example, the H₂ storage tanks 208A, 208B and the O₂ storage tank 212 each comprise one or more gas bottles that respectively store hydrogen and oxygen. In some cases, the O₂ storage tank 212 may store oxygen in the form of hydrogen peroxide (H₂O₂) that is then converted to water (H₂O) and oxygen (O₂) using a catalyst. In some cases, the hydrogen in the H₂ storage tanks 208A, 208B may be stored in the form of ammonia, metal hydride, and/or the like before being converted to hydrogen (e.g., via reaction(s) with other compounds to release the hydrogen).

In some cases, the H₂ storage tanks 208A, 208B and the O₂ storage tank 212 may be rated for external pressure, such that the H₂ storage tanks 208A, 208B and the O₂ storage tank 212 can be submerged to various depths without the risk of damage to the storage tanks. In other cases, the H₂ storage tanks 208A, 208B and/or the O₂ storage tank 212 may not be rated for external pressure. In such cases, a maximum allowable depth of the AUV 104 and/or the fuel cell module 152 in water may be set to equal the maximum depth rating of the AUV 104 or the depth equivalent to the internal supply pressure of the H₂ storage tanks 208A, 208B or the O₂ storage tank 212 with the lowest internal pressure, whichever provides the least depth capacity. In these cases, the depth of the AUV 104 and/or the fuel cell module 152 in water may be continuously monitored and controlled to avoid exceeding the maximum allowable depth.

The regulator 216 and the regulator 220 may respectively regulate the hydrogen and oxygen that flows from the H₂ storage tanks 208A, 208B and the O₂ storage tank 212 into the FCC 204. In one example, the regulator 216 and the regulator 220 may comprise isolation valves that can be manually and/or electrically actuated, such that a user and/or a controller (e.g., VCC 160) can regulate the flow of hydrogen and/or oxygen into the FCC 204. The isolation valves may also be positioned between the storage tanks and a housing of the FCC 204 to mitigate or prevent reactant leakage into an interior of the FCC 204 when the fuel cell module 152 is in storage, being transported, or when powered off. The regulator 216 may be placed in series between the H₂ storage tanks 208A, 208B and the FCC 204, and the regulator 220 may be placed in series between the O₂ storage tank 212 and the FCC 204. Such placement of the regulators 216, 220 may result in isolation between each reactant storage container and the FCC 204, improving overall safety of the fuel cell module 152.

The heat exchanger(s) 228A-228N may be or comprise components suitable for regulating heat generated by the FCC 204. In one example, the heat exchanger(s) 228A-228N comprise three heat exchangers: a first heat exchanger 228A, a second heat exchanger 228B, and a third heat exchanger 228C. However, it is to be appreciated that an additional or alternative number of heat exchangers may be used. The heat exchanger(s) 228A-228N may each include one or more cooling pumps that pump coolant (e.g., deionized fresh water, glycol, etc.) into the FCC 204 to absorb heat from one or more components of the FCC 204. In some cases, the heat exchanger(s) 228A-228N may recycle coolant via heat exchange with ocean water. In other words, coolant that has absorbed heat from the FCC 204 may be pumped back into the heat exchanger(s) 228A-228N to release heat into the surrounding ocean water, and then subsequently be pumped back into the FCC 204 to absorb additional heat from the FCC 204. In cases where there is no ocean water or other ambient fluid (e.g., the FCC 204 operates in air with the pressure vessel housing around the FCC 204 removed), additional coolant may be provided to the heat exchanger(s) 228A-228N to remove heat therefrom.

The ballast water tank(s) 224 may be part of a waste management system (described in further detail below) and may receive wastewater generated from operation of the FCC 204. For example, the FCC 204 may accumulate wastewater during operation, and the wastewater may be pumped out of the FCC 204 and into the ballast water tank(s) 224. The fuel cell module 152 may retain the wastewater (instead of discarding the wastewater into the ocean or other receptacle outside the fuel cell module 152) to preserve the overall weight of the fuel cell module 152 regardless of the amount of unused reactant remaining in the H₂ storage tanks 208A, 208B and/or the O₂ storage tank 212. In some cases, the ballast water tank(s) 224 may be mounted to the structural frame of the fuel cell module 152 and may contain internal baffles suitable for preventing irregular movement of the wastewater (e.g., sloshing, splashing, etc.) within the ballast water tank(s) 224 when, for example, the AUV 104 performs a maneuver. The internal baffles may in this way improve the stability of the AUV 104 during operation. In some cases, the ballast water tank(s) 224 may be drained during or after the AUV 104 has performed one or more tasks associated with a planned mission.

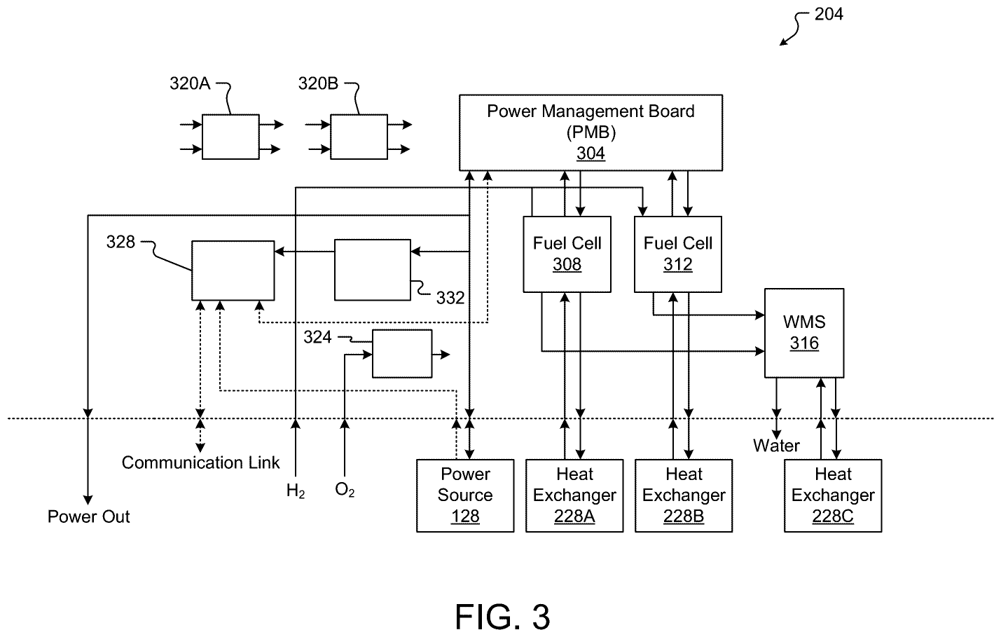

Aspects of the FCC 204 with now be described with reference to FIG. 3, which depicts example aspects of the FCC 204 according to at least one example embodiment. The FCC 204 is illustrated to comprise a power management board (PMB) 304, a fuel cell 308, a fuel cell 312, a waste management system (WMS) 316, hydrogen scrubbers 320A-320N, an oxygen regulator 324, a fuel cell control computer (FCCC) 328, and a power source 332. It is to be appreciated that additional or alternative components may be included in other examples.

The PMB 304 may comprise processing circuitry and memory (which may be similar to or the same as the processing circuitry 116 and the memory 124) suitable for managing operation of the fuel cells 308, 312, power generated by the fuel cells 308, 312, and the flow of coolant (e.g., provided by one or more of the heat exchanger(s) 228A-228N) through components of the FCC 204. The PMB 304 may in some cases communicate with one or more components of the FCC 204 (e.g., the FCCC 328) through wired and/or wireless communication.

The fuel cell 308 and the fuel cell 312 may each be or comprise proton exchange membrane (PEM) fuel cells that include a proton exchange membrane, a cathode, and an anode. The fuel cell 308 and the fuel cell 312 may each receive hydrogen and oxygen as inputs (e.g., from the H₂ storage tanks 208A, 208B and the O₂ storage tank 212, respectively) and generate power via electrochemical reactions. While two fuel cells are depicted, it is to be understood that an additional or alternative number of fuel cells may be present, and the FCC 204 may comprise a different number of fuel cells depending on, for example, the planned mission of the AUV 104. Each of the fuel cell 308 and the fuel cell 312 may comprise air blowers and/or coolant pumps to enable interactions with one or more heat exchanger(s) (e.g., heat exchanger(s) 228A-228N). In one case depicted in FIG. 3, the first heat exchanger 228A may interface with the fuel cell 308 and the second heat exchanger 228B may interface with the fuel cell 312 to provide coolant to respectively absorb heat generated by operation of the fuel cell 308 and the fuel cell 312.

In one example, the fuel cell 308 and/or the fuel cell 312 may operate as an “air breathing” fuel cell. In the case of an “air breathing” fuel cell, the oxygen regulator 324 may feed in a steady stream of oxygen into a chamber of the FCC 204 to maintain the oxygen level inside the FCC 204 at approximately atmospheric ratios (e.g., about 21% oxygen). Stated differently, the nitrogen to oxygen gas ratio inside the chamber of the FCC 204 may be continuously monitored and oxygen consumed by the fuel cell 308 and/or the fuel cell 312 may be replenished by the oxygen regulator 324 to normal atmospheric conditions. In some examples, the FCC 204 may operate in open air with external pressure housing of the fuel cell module 152 removed (e.g., the AUV 104 is above the water's surface and the fuel cell module 152 is charging one or more components of the AUV 104). In some “air breathing” fuel cell examples, the oxygen regulator 324 and/or the FCC 204 may comprise oxygen sensor(s) or similar sensors suitable for determining an amount of oxygen present in the FCC 204, flowing through the oxygen regulator 324, combinations thereof, and/or the like. The oxygen sensor information may be used by the FCCC 328, for example, to automatically control the flow rate of oxygen into the FCC 204 to maintain an appropriate amount of oxygen in the FCC 204.

In another example, the fuel cell 308 and/or the fuel cell 312 may comprise a “direct oxygen” fuel cell. In this case, the oxygen regulator 324 may be connected to the fuel cell 308 and/or the fuel cell 312 and may feed the oxygen gas directly into the fuel cell 308 and/or the fuel cell 312. In some cases and similar to the “air breathing” fuel cell example, the oxygen regulator 324 and/or the FCC 204 may comprise oxygen sensor(s) or other sensors suitable for determining the amount of oxygen present in the FCC 204, which sensor information may be used by the FCCC 328 to automatically control the flow rate of oxygen into the fuel cell 308 and/or the fuel cell 312.

The hydrogen scrubbers 320A-320N may be or comprise components suitable for converting hydrogen into wastewater by combining the hydrogen with oxygen. In one example, the hydrogen scrubbers 320A-320N comprise two hydrogen scrubbers: a first hydrogen scrubber 320A and a second hydrogen scrubber 320B. In other examples, an additional or alternative number of hydrogen scrubbers may be present. The hydrogen scrubbers 320A-320N may capture any hydrogen leaked into the internal atmosphere of the FCC 204 and react the captured hydrogen with oxygen to generate wastewater. The use of hydrogen scrubbers 320A-320N may improve the safety of the FCC 204 may mitigating the likelihood of accumulated concentrations of hydrogen gas within the internal atmosphere of the FCC 204.

The WMS 316 may comprise one or more components suitable for managing waste products (e.g., wastewater, hydrogen, oxygen, etc.) generated by operation of the FCC 204. The WMS 316 comprises one or more wastewater pumps that pump wastewater accumulated in a condenser of the fuel cell 308 and/or the fuel cell 312 to external wastewater tanks (e.g., ballast water tank(s) 224). The pumping into the external wastewater tanks may occur at any depth of the submerged AUV 104. In other words, the WMS 316 may operate to fill the external wastewater tanks while the AUV 104 is underwater or otherwise operational. The WMS 316 may additionally or alternatively pump water from a reservoir of a condenser of the FCC 204 (e.g., a condenser that captures wastewater emitted into the internal atmosphere of the FCC 204 from the fuel cell 308, 312, from the hydrogen scrubbers 320A-320N, etc.). In one example, the WMS 316 is part of the FCCC 328, while in another example the WMS 316 is operated independently from the FCCC 328. The electronics associated with the WMS 316 (e.g., processing circuitry and memory) may be packaged to withstand the interior environment of the FCC 204 (e.g., hot and/or wet conditions). In some cases, the WMS 316 may interface with one or more heat exchangers (e.g., one or more of the heat exchanger(s) 228A-228N). In such cases, the WMS 316 may comprise water pumps that pump coolant in from the heat exchanger(s) to cool the wastewater before the wastewater is pumped to the external wastewater tanks.

The FCCC 328 may be or comprise hardware and/or software components suitable for carrying out the functions of the FCCC 328 as described herein. In one example, the FCCC 328 may comprise a processor and memory coupled thereto that stores instructions for execution by the processor. The FCCC 328 may comprise one or more communications links or interfaces (similar to the communication interface 148) that enable the FCCC 328 to communicate with one or more components of the AUV 104, the vessel 108, the post-mission processor 112, the external positioning system 114, and/or the like. For example, the FCCC 328 may be connected to the VCC 160 via an Ethernet connection.

The power source 332 may be similar to or the same as the power source 128, and may provide power to one or more components in the FCC 204. In one example, the power source 332 may comprise a rechargeable battery that receives power generated by the fuel cells 308, 312 and that provides power to the PMB 304 and the FCCC 328.

The FCCC 328 may be directed by a user (e.g., a human pilot) and/or the VCC 160 to operate the FCC 204. The FCCC 328 may in some cases cause the FCC 204 and/or components thereof (e.g., the fuel cells 308, 312, the WMS 316, etc.) to be powered on or off. For example, it may be desirable for the AUV 104 to operate using the power source 128, so the fuel cell module 152 may be powered down. The powering down of the fuel cell module 152 may reduce overall noise generated by the AUV 104/fuel cell module 152 assembly and may additionally or alternatively occur due to issues with the fuel cell module 152 (e.g., an unsafe level of hydrogen is detected in the FCC 204).

In some cases, the FCCC 328 may receive commands from and/or send data to the user and/or the VCC 160. In one example and as previously discussed, the FCCC 328 may receive a command to start or stop generating power. In another example, the FCCC 328 may receive from the user and/or the VCC 160 emergency shutdown commands and/or commands for direct control of devices or other components of the FCC 204 (e.g., commands to control the hydrogen scrubbers 320A-320N, commands to control the WMS 316, etc.). The data sent from the FCCC 328 to the user (e.g., via a graphical user interface) and/or the VCC 160 may comprise performance information, operating state, fuel supply information, gas pressure information, voltage measurements, current measurements, temperature measurements, gas concentrations, humidity information, alerts, data, sensor values, other performance and diagnostic data, and/or the like. In yet another example, the user and/or the VCC 160 may control an operational mode of the fuel cell module 152 via the FCCC 328.

One operational mode of the fuel cell module 152 may comprise a hybrid mode. While in the hybrid mode, the fuel cells 308, 312 may turn on and generate power only when the power source 128 of the AUV 104 falls below a specified state of charge (e.g., a threshold charge value, a threshold charge percentage, etc.), and then turn off once the power source 128 is above the specified state of charge. For example, the specified state of charge may be 60% charge, such that the fuel cells 308, 312 turn on when the power source 128 charge falls below 60% charge and remain on to provide power to the power source 128 until the power source 128 charge reaches 60%. After the power source 128 reaches 60% charge, the fuel cells 308, 312 turn off. As a result, the FCC 204 cycles between an “off” state and an “on” state. The FCC 204 may generate power at an efficiency point that is at a higher power level than that needed by the AUV 104 during normal operation. This may maximize the efficiency of the FCC 204 by avoiding the need to operate at a lower power generation than the optimum point.

Another operational mode may comprise a load following mode. While in the load following mode, the fuel cells 308, 312 may throttle power generation to keep the power source 128 at a specified state of charge at all times. As a result, the fuel cell power generation may adjust to match the power consumption of the AUV 104 and keeping the power source 128 near a full charged state at all times. In instances where the AUV 104 requires high power, the power source 128 may respond and the fuel cells 308, 312 may be turned on by the FCCC 328 and slowly ramped up to restore the power source 128 to a fully charged state. In instances where the power draw of the power source 128 exceeds the maximum power generation of the FCC 204, the state of charge of the power source 128 decreases continuously until the power demand is reduced and the FCC 204 can return the power source 128 to a fully charged state. As a result, efficiency losses from powering the fuel cells 308, 312 on and off are minimized.

The user and/or the VCC 160 may change the operation mode of the FCC 204 via commands sent to the FCCC 328, which may receive the commands and adjust operation of one or more components of the FCC 204 accordingly. For example, the user may desire to switch the FCC 204 from a load following mode to a hybrid mode. The user may send a signal (e.g., via a graphical user interface) to the fuel cell module 152. The signal may be received by the FCCC 328, and the FCCC 328 may adjust operation of the fuel cells 308, 312 to match the hybrid mode of operation.

The FCCC 328 may send information related to the status of the FCC 204 and/or components thereof to the user and/or to the VCC 160 (e.g., whether the FCC 204 is turned on, whether one or more events such as safety violations have occurred, etc.). In one example, the FCCC 328 may send an alert to the user and/or the VCC 160 indicating that the FCC 204 has experienced a violation of one or more safety parameters (e.g., a concentration of hydrogen and/or oxygen has exceeded a threshold value). In some cases, the AUV 104 (whether automatically using the VCC 160 or via user intervention) may replan one or more aspects of a mission and/or execute a fault response after receiving the alert. For example, the alert may indicate a fault in one or more of the fuel cells, such that additional power from the fuel cell module 152 may be unavailable until the fault is addressed. The VCC 160 may then determine a charge of the power source 128 and replan the mission of the AUV 104 accordingly (e.g., removing one or more navigation legs of the mission to conserve power). In another example, FCCC 328 may send an alert indicating that the concentration of hydrogen has exceeded a threshold value. In this example, the alert may prevent the VCC 160 from sending commands to the FCCC 328 to activate the fuel cells 308, 312 until the VCC 160 receives another signal indicating that the concentration of hydrogen has decreased below the threshold value.

The FCCC 328 may automatically disable one or more components of the FCC 204 when a detected amount of hydrogen gas in the FCC 204 reaches a predetermined percentage of a lower explosion limit (the lowest concentration that will produce a flash of fire in the presence of an ignition source) or when the detected amount of oxygen reaches a safety limit (e.g., a safety limit described in regulation). In one example, the FCC 204 may be disabled when one or more safety parameters are violated, such as when the concentration of hydrogen reaches a threshold value (e.g., 60% of the lower explosion limit) and/or when the concentration of oxygen in the atmosphere of the FCC 204 reaches a threshold value (e.g., 23.5% oxygen). The FCCC 328 may also generate a warning when the concentration of hydrogen is at a lower percentage of the lower explosion limit than the automatic shutdown to allow an operator (e.g., a human pilot) and/or the VCC 160 additional time to resolve the issue before the FCCC 328 automatically disables the FCC 204 and/or components thereof. The FCCC 328 may manage the operation and safety of the FCC 204 using processing circuitry separate and/or independent from the processing circuitry 116 of the VCC 160, such that operation and safety of the FCC 204 is managed by a stand-alone system that does not require the VCC 160 to ensure that the FCC 204 operates safely.

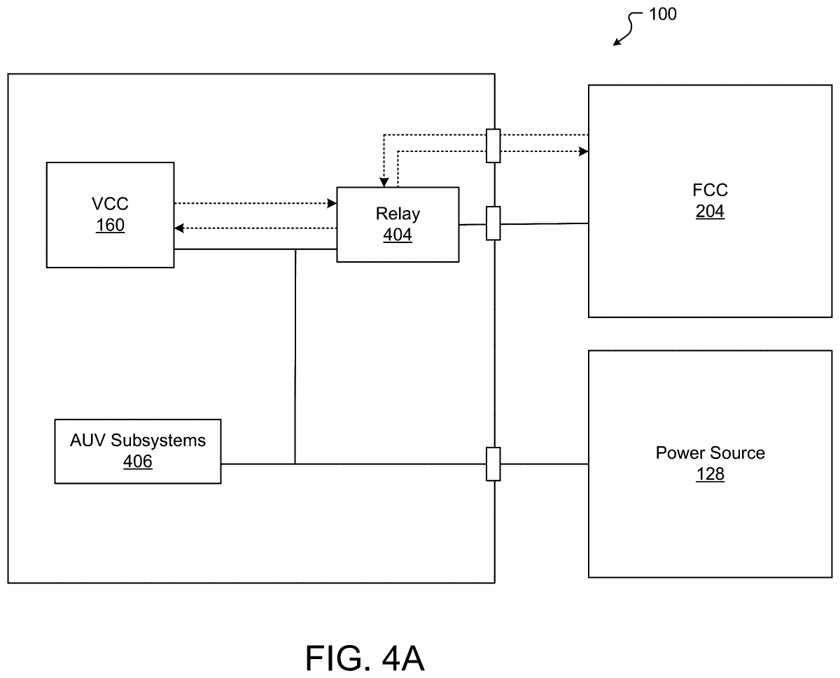

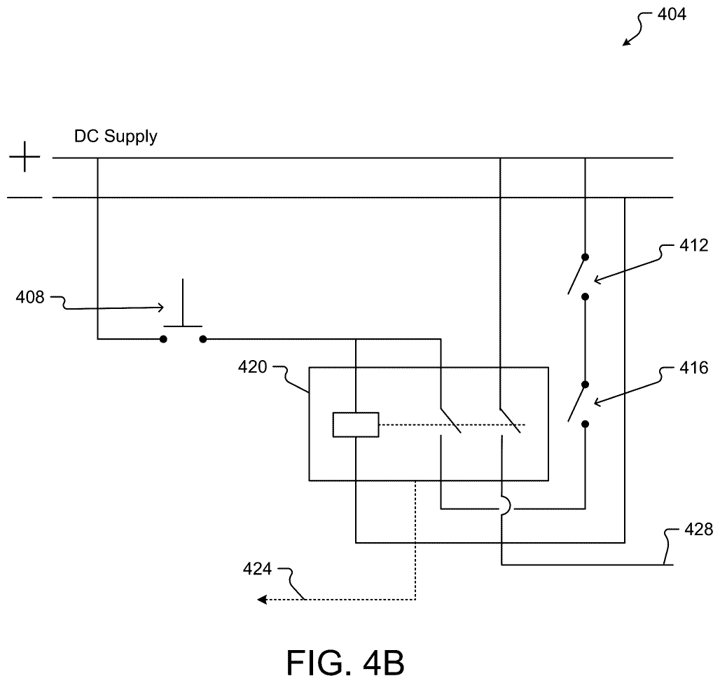

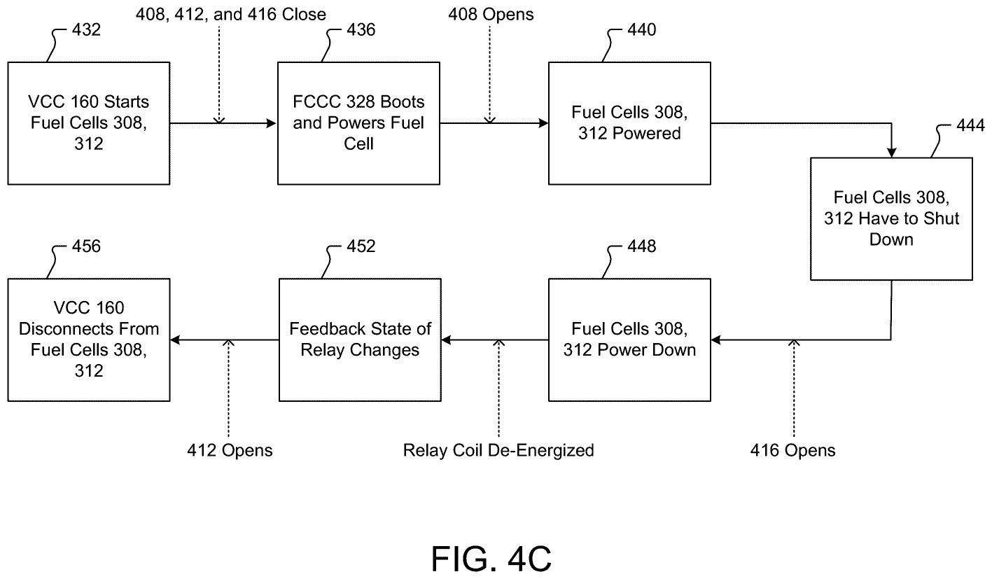

With reference to FIGS. 4A-4C, a relay 404 may be used to enable communications between the FCCC 328 and the VCC 160 (or other computer such as a computer of an operator of the AUV 104). In one case, the FCCC 328 may monitor the fuel cells of the FCC 204 independently from the VCC 160 and may use the relay 404 to communicate with the VCC 160 (e.g., sending indicators that the FCC 204 has experienced a fault or is otherwise powered off, receive instructions from the VCC 160 to turn on the fuel cells to generate power, etc.). The relay 404 may be positioned between and electrically connected to the FCC 204 and the VCC 160. The relay 404 may enable either the FCC 204 or the VCC 160 to power down one or more components of the FCC 204 (e.g., the fuel cells 308, 312) if an unsafe condition is detected (e.g., the concentration of hydrogen exceeds a threshold value).

In one embodiment, the relay 404 enables the VCC 160 to determine that the FCCC 328 or other components of the fuel cell module 152 have shut down without needing to power on the FCCC 328. In other words, the relay 404 may enable the AUV 104 and/or user of the AUV 104 to determine one or more issues with the fuel cell module 152 without needing to power on one or more components of the fuel cell module 152. This may beneficially reduce or prevent the VCC 160 from powering on the fuel cell module 152 in the presence of unsafe conditions (e.g., unsafe concentrations of hydrogen gas in the FCC 204). The relay 404 comprises a VCC start relay 408, a AUV hold relay 412, a fuel cell kill relay 416 (which may be positioned within the PMB 304), and a latching relay 420 positioned as shown in FIG. 4B.

With reference to FIG. 4C, an example state diagram of operation of the relay 404 to enable the AUV 104 to connect and/or disconnect from the fuel cell module 152 is depicted in accordance with at least one example embodiment. In an initial state where the AUV 104 is connected to the fuel cell module 152 and the FCC 204 is not operating (e.g., the fuel cells 308, 312 are disabled or otherwise turned off), the VCC start relay 408 may be in an open state, the AUV hold relay 412 may be in an open state, the fuel cell kill relay 416 may be in a closed state, and a coil in the latching relay 420 may be un-energized. At operation 432, the VCC 160 may send a start command to the fuel cell module 152 to turn on one or more fuel cells, such as the fuel cell 308 and the fuel cell 312. This may occur, for example, when the VCC 160 determines that the power source 128 requires charging by the fuel cell module 152. The start command from the VCC 160 results in the relay 404 closing. In other words, switches associated with the VCC start relay 408, the AUV hold relay 412, and the fuel cell kill relay 416 may all be switched to a closed state to enable current flow. The closing of the switches may cause a double throw latching relay the latching relay 420 to close, which in turn closes a power contractor relay 428 connected to the FCCC 328, enabling current to flow to the FCCC 328. At operation 436, the FCCC 328 turns on and powers the fuel cells 308, 312. The VCC start relay 408 may then switch to an open state. At operation 440, the fuel cells 308, 312 are powered and generate power that is sent to the power source 128 and/or other AUV subsystems 406 (e.g., the propulsion devices 140, the buoyancy system 144, etc.), to the power source 332 and/or other components of the fuel cell module 152, combinations thereof, and the like.

The fuel cells 308, 312 may continuously generate power until operation 444. At operation 444, one or more events may necessitate the shutting down of fuel cells 308, 312. The fuel cells 308, 312 may shut down for a variety of reasons (e.g., concentrations of the reactants have reached or exceeded predetermined threshold values, one or more faults have been detected in one or more components of the fuel cell module 152, the power source 128 is fully charged, etc.). After the fuel cells 308, 312 shut down at operation 448, the coil within the latching relay 420 may be de-energized. At operation 452, the latching relay 420 may send relay feedback 424 to the VCC 160 as a result of the latching relay 420 being de-energized. The relay feedback 424 may indicate to the VCC 160 that the FCC 204 is no longer producing power. In some cases, the relay feedback 424 may comprise additional or alternative information such as information about the at least one event (e.g., information about the concentrations of hydrogen and/or oxygen in the FCC 204, information about the operation of the PMB 304, etc.). The VCC 160 may, after receiving the relay feedback 424, subsequently send a command to the relay 404 to open the AUV hold relay 412. The VCC 160 may then disconnect from the fuel cells 308, 312 at operation 456 via opening of the power contractor relay 428. As a result, the VCC 160 can receive information from the relay 404 that the FCC 204 has been disabled without the need to energize the components of the FCC 204 to make such a determination. This may beneficially enhance the overall safety of the system 100, for example because the VCC 160 does not need to introduce power into a potentially dangerous environment in the FCC 204 to determine that a fault or other issue has occurred.

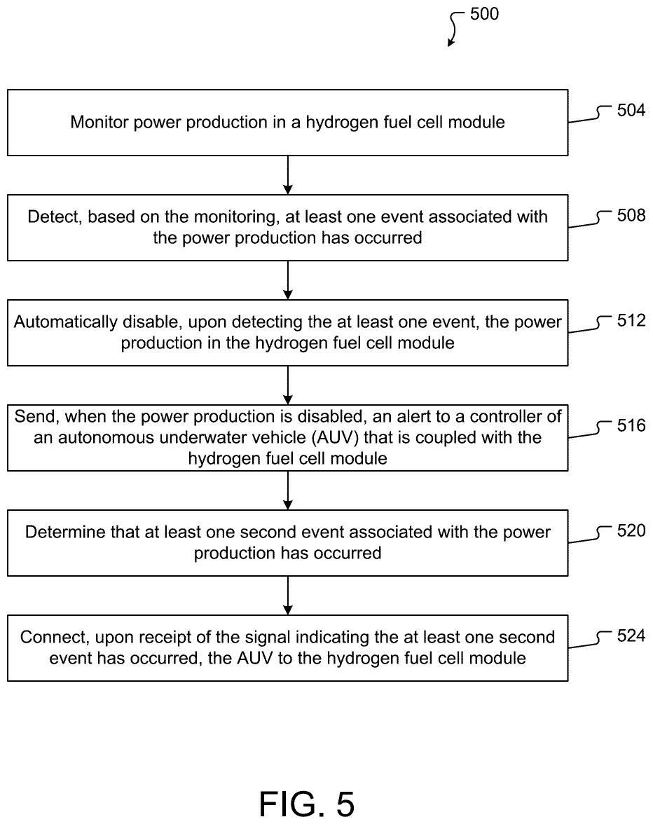

FIG. 5 illustrates a method 500 for disconnecting the AUV 104 from the fuel cell module 152 according to at least one example embodiment. The method 500 may be carried out by various elements described herein, including by the processing circuitry 116 of the VCC 160, the relay 404, and the components of the fuel cell module 152 (e.g., the FCCC 328). FIG. 5 will be discussed with reference to the foregoing components, but the method 500 may be applied for additional or alternative fuel cell modules and/or AUVs.

Operation 504 includes monitoring power production in a hydrogen fuel cell module. The monitoring may be performed by a user (e.g., a human pilot of the AUV 104), the VCC 160, the PMB 304, and/or the FCCC 328. In one example, the FCCC 328 may monitor one or more sensor measurements associated with operation of the FCC 204, such as measurements about the concentration of reactants in the atmosphere of the FCC 204. The monitoring may comprise the FCCC 328 sending information to the user and/or the VCC 160 associated with the operation of the FCC 204.

Operation 508 includes detecting, based on the monitoring, at least one event associated with the power production has occurred. The at least one event may correspond to the violation of one or more safety parameters, such as the concentration of hydrogen meeting or exceeding a threshold value (e.g., a percentage of the lower explosion limit) and/or the concentration of oxygen meeting or exceeding a threshold value (e.g., a safety limit on the amount of oxygen as prescribed by regulation). In another example, the at least one event may be a malfunction, fault, or other issue with one or more components of the FCC 204 (e.g., the hydrogen scrubbers 320A-320N are no longer functioning properly, the temperature of the fuel cells 308, 312 has exceeded a predetermined threshold value, a cooling pump associated with the first heat exchanger 228A has powered down, etc.).

Operation 512 includes automatically disabling, upon detecting the at least one event, the power production in the hydrogen fuel cell module. In some cases, the automatic disabling may be performed by the FCCC 328 after the FCCC 328 detects the at least one event. In some cases, the disabling may be performed by the user (e.g., via a graphical user interface) after information about the at least one event has been provided by the FCCC 328 to the user.

Operation 516 includes sending, when the power production is disabled, an alert to a controller of an AUV that is coupled with the hydrogen fuel cell module. The operation 516 may comprise the relay 404 providing relay feedback 424 to the user (e.g., via a graphical user interface) and/or the VCC 160 indicating that the at least one event has been detected. The relay feedback 424 may comprise additional information about the at least one event, including sensor information, information about which components have faulted, failed, and/or have otherwise been disabled, combinations thereof, and/or the like. In some cases, upon receiving the relay feedback 424 the VCC 160 may automatically disconnect the fuel cell module 152 from the AUV 104.

Operation 520 includes determining that at least one second event associated with the power production has occurred. The at least one second event may correspond to a correction, remedy, or other change to the fuel cell module 152 that addresses the at least one event. For example, the at least one second event may comprise the concentration of hydrogen decreasing below the threshold value and/or the concentration of oxygen decreasing below the threshold value. As another example, the at least one second event may comprise the hydrogen scrubbers 320A-320N being operational again after a reboot. The user, the VCC 160, the FCCC 328, and/or the like may determine that the at least one second event has occurred (e.g., based on measurements of the FCC 204, based on inputs from the user that override the hardware and/or software of the fuel cell module 152, etc.).

Operation 524 includes connecting, upon receipt of the signal indicating that the at least one second event has occurred, the AUV to the hydrogen fuel cell module. When the at least one second event has occurred, the FCCC 328 may send one or more signals to the VCC 160. The one or more signals may comprise an indicator that the at least one second event has occurred and may additionally comprise information about the at least one second event (e.g., sensor readings). The VCC 160 may, upon receipt of the signal, reconnect the AUV 104 to the fuel cell module 152.

In some cases, the operations of the method 500 may be repeated as the AUV 104 performs one or more missions. For instance, the FCCC 328 may continuously monitor the hydrogen fuel cell module to detect one or more events that require the fuel cell module to shut down. After the events are resolved, signals sent to the AUV 104 may enable the VCC 160 to reactivate the fuel cell module 152.

As may be appreciated, the operations of the method 500 are performed autonomously and are carried out without corresponding human input (other than the human input to program the AUV to perform the autonomous operations). However, more or fewer operations of the method 500 may exist and/or more or fewer operations of the method may be performed autonomously.

It should be understood that various aspects disclosed herein may be combined in different combinations than the combinations specifically presented in the description and accompanying drawings. It should also be understood that, depending on the example or embodiment, certain acts or events of any of the processes or methods described herein may be performed in a different sequence, and/or may be added, merged, or left out altogether (e.g., all described acts or events may not be necessary to carry out the disclosed techniques according to different embodiments of the present disclosure). In addition, while certain aspects of this disclosure are described as being performed by a single module or unit for purposes of clarity, it should be understood that the techniques of this disclosure may be performed by a combination of units or modules associated with, for example, a computing device.

It should be appreciated that inventive concepts cover any embodiment in combination with any one or more other embodiments, any one or more of the features disclosed herein, any one or more of the features as substantially disclosed herein, any one or more of the features as substantially disclosed herein in combination with any one or more other features as substantially disclosed herein, any one of the aspects/features/embodiments in combination with any one or more other aspects/features/embodiments, use of any one or more of the embodiments or features as disclosed herein. It is to be appreciated that any feature described herein can be claimed in combination with any other feature(s) as described herein, regardless of whether the features come from the same described embodiment.

Specific details were given in the description to provide a thorough understanding of example embodiments. However, it will be understood by one of ordinary skill in the art that example embodiments may be practiced without these specific details. In other instances, well-known circuits, processes, algorithms, structures, and techniques may be shown without unnecessary detail in order to avoid obscuring the embodiments.

While illustrative embodiments of the disclosure have been described in detail herein, it is to be understood that the inventive concepts may be otherwise variously embodied and employed, and that the appended claims are intended to be construed to include such variations, except as limited by the prior art.

It should be understood that the terms “first,” “second,” “third,” etc. are used for convenience of description and do not limit example embodiments. For example, a particular element may be referred to a “first” element in some cases, and a “second” element in other cases without limiting example embodiments.

As used herein, the singular forms “a,” “an,” and “the” are intended to include the plural forms as well, unless the context clearly indicates otherwise. It will be further understood that the terms “include,” “including,” “includes,” “comprise,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. The term “and/or” includes any and all combinations of one or more of the associated listed items.

The phrases “at least one,” “one or more,” “or,” and “and/or” are open-ended expressions that are both conjunctive and disjunctive in operation. For example, each of the expressions “at least one of A, B and C,” “at least one of A, B, or C,” “one or more of A, B, and C,” “one or more of A, B, or C,” “A, B, and/or C,” and “A, B, or C” means A alone, B alone, C alone, A and B together, A and C together, B and C together, or A, B and C together.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

The term “automatic” and variations thereof, as used herein, refers to any process or operation, which is typically continuous or semi-continuous, done without material human input when the process or operation is performed. However, a process or operation can be automatic, even though performance of the process or operation uses material or immaterial human input, if the input is received before performance of the process or operation.

Aspects of the present disclosure may take the form of an embodiment that is entirely hardware, an embodiment that is entirely software (including firmware, resident software, micro-code, etc.) or an embodiment combining software and hardware aspects that may all generally be referred to herein as a “circuit,” “module,” or “system.” Any combination of one or more computer-readable medium(s) may be utilized. The computer-readable medium may be a computer-readable signal medium or a computer-readable storage medium.

A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer-readable storage medium may be any tangible medium that can contain or store a program for use by or in connection with an instruction execution system, apparatus, or device.

A computer-readable signal medium may include a propagated data signal with computer-readable program code embodied therein, for example, in baseband or as part of a carrier wave. Such a propagated signal may take any of a variety of forms, including, but not limited to, electro-magnetic, optical, or any suitable combination thereof. A computer-readable signal medium may be any computer-readable medium that is not a computer-readable storage medium and that can communicate, propagate, or transport a program for use by or in connection with an instruction execution system, apparatus, or device. Program code embodied on a computer-readable medium may be transmitted using any appropriate medium, including, but not limited to, wireless, wireline, optical fiber cable, RF, etc., or any suitable combination of the foregoing.

The terms “determine,” “calculate,” “compute,” and variations thereof, as used herein, are used interchangeably and include any type of methodology, process, mathematical operation or technique.

Example embodiments may be configured as follows:

(1) A system, comprising:
a processor; and
a memory coupled with the processor and storing instructions thereon that, when executed by the processor, enable the processor to:
   monitor power production in a hydrogen fuel cell module;
   detect, based on the monitoring, at least one event associated with the power production has occurred;
   automatically disable, upon detecting the at least one event, the power production in the hydrogen fuel cell module; and
   send, when the power production is disabled, an alert to a controller of an autonomous underwater vehicle (AUV) that is coupled with the hydrogen fuel cell module.

(2) The system of (1), wherein the at least one event comprises a violation of at least one safety parameter.

(3) The system of (2), wherein the at least one safety parameter comprises at least one of a concentration of hydrogen reaching or exceeding a threshold value and a concentration of oxygen reaching or exceeding a threshold value.

(4) The system of one or more of (1) to (3), wherein the alert comprises at least one of an indicator that the hydrogen fuel cell module has been disabled and information associated with the at least one event.

(5) The system of one or more of (1) to (4), wherein the controller of the AUV disconnects the AUV from the hydrogen fuel cell module upon receipt of the alert.

(6) The system of one or more of (1) to (5), wherein the instructions further enable the processor to:
determine at least one second event associated with the power production has occurred; and
send, when the at least one second event has occurred, a signal to the controller.

(7) The system of (6), wherein the at least one second event comprises at least one of a concentration of hydrogen decreasing below a threshold value and a concentration of oxygen decreasing below a threshold value, and wherein the controller of the AUV connects the AUV to the hydrogen fuel cell module upon receipt of the signal.

(8) The system of one or more of (1) to (7), wherein the instructions further enable the processor to:
receive, from the controller, a signal; and
enable, upon receipt of the signal, the power production in the hydrogen fuel cell module.

(9) A method, comprising:
monitoring power production in a hydrogen fuel cell module;
detecting, based on the monitoring, at least one event associated with the power production has occurred;
automatically disabling, upon detecting the at least one event, the power production in the hydrogen fuel cell module; and
sending, when the power production is disabled, an alert to a controller of an autonomous underwater vehicle (AUV) that is coupled with the hydrogen fuel cell module.

(10) The method of (9), wherein the at least one event comprises a violation of at least one safety parameter.

(11) The method of (10), wherein the at least one safety parameter comprises at least one of a concentration of hydrogen meeting or exceeding a threshold value and a concentration of oxygen meeting or exceeding a threshold value.

(12) The method of one or more of (9) to (11), further comprising:
disconnecting, upon receipt of the alert by the controller, the AUV from the hydrogen fuel cell module.

(13) The method of one or more of (9) to (12), further comprising:
determining that at least one second event associated with the power production has occurred; and
sending, when the at least one second event has occurred, a signal to the controller.

(14) The method of (13), wherein the at least one second event comprises at least one of a concentration of hydrogen decreasing below a threshold value and a concentration of oxygen decreasing below a threshold value.

(15) The method of (14), further comprising:
connecting, upon receipt of the signal, the AUV to the hydrogen fuel cell module.

(16) The method of one or more of (9) to (15), further comprising:
receiving, from the controller of the AUV, a signal; and
changing, upon receipt of the signal, an operation mode of the hydrogen fuel cell module.

(17) The method of one or more of (9) to (16), further comprising:
replanning, based on the automatic disabling of the power production in the hydrogen fuel cell module, a mission associated with the AUV.

(18) A system, comprising:
an underwater autonomous vehicle (AUV) comprising a controller; and
a hydrogen fuel cell module in electrical communication with the controller of the AUV, the hydrogen fuel cell module comprising:
   a processor; and
   a memory coupled with the processor and storing instructions thereon that, when executed by the processor, enable the processor to:
      monitor power production in the hydrogen fuel cell module;
      detect, based on monitoring the power production, at least one event associated with the power production in the hydrogen fuel cell module has occurred;
      automatically disable, upon detecting the at least one event, the power production in the hydrogen fuel cell module; and
      send, when the power production is disabled, an alert to the controller of the AUV.

(19) The system of (18), wherein the instructions further enable the processor to:
determine at least one second event associated with the power production in the hydrogen fuel cell module has occurred; and
send, when the at least one second event has occurred, a signal to the controller.

(20) The system of (19), wherein the at least one second event comprises at least one of a concentration of hydrogen decreasing below a threshold value and a concentration of oxygen decreasing below a threshold value.

(21) A system, comprising:
an Autonomous Underwater Vehicle (AUV) comprising a controller and a power source;
a fuel cell module that reacts hydrogen and oxygen to charge the power source; and
a wastewater tank, wherein wastewater from the fuel cell module is collected in a fuel cell module canister and pumped into the wastewater tank.

(22) The system of (21), wherein the wastewater tank comprises one or more baffles.

(23) The system of one or more of (21) to (22), wherein the controller comprises:
a processor; and
a memory coupled with the processor and storing instructions thereon that, when executed by the processor, cause the processor to:
control an operation mode of the fuel cell module.

(24) The system of (23), wherein the operation mode comprises at least one of a hybrid mode and a load following mode.

(25) The system of (24), wherein, when in the hybrid mode, the fuel cell module is turned on and off cyclically.

(26) The system of (25), wherein, when in the load following mode, power output from the fuel cell module is throttled to maintain a charge of the power source at a first charge state.

(27) The system of (23), wherein the oxygen is fed into a chamber of the fuel cell module.

(28) The system of (27), wherein a concentration of the oxygen in the chamber is about 21%.

(29) The system of (23), wherein the oxygen is fed directly into a fuel cell of the fuel cell module.

(30) The system of one or more of (21) to (29), further comprising:
a heat exchanger, wherein the wastewater interfaces with the heat exchanger before the wastewater is pumped into the wastewater tank.

What is claimed is:

1. A system, comprising:
a processor; and
a memory coupled with the processor and storing instructions thereon that, when executed by the processor, enable the processor to:
monitor power production in a hydrogen fuel cell module;
detect, based on the monitoring, at least one event associated with the power production has occurred;
automatically disable, upon detecting the at least one event, the power production in the hydrogen fuel cell module; and
send, when the power production is disabled, an alert to a controller of an autonomous underwater vehicle (AUV) that is coupled with the hydrogen fuel cell module.

2. The system of claim 1, wherein the at least one event comprises a violation of at least one safety parameter.

3. The system of claim 2, wherein the at least one safety parameter comprises at least one of a concentration of hydrogen reaching or exceeding a threshold value and a concentration of oxygen reaching or exceeding a threshold value.

4. The system of claim 1, wherein the alert comprises at least one of an indicator that the hydrogen fuel cell module has been disabled and information associated with the at least one event.

5. The system of claim 1, wherein the controller of the AUV disconnects the AUV from the hydrogen fuel cell module upon receipt of the alert.

6. The system of claim 1, wherein the instructions further enable the processor to:
determine at least one second event associated with the power production has occurred; and
send, when the at least one second event has occurred, a signal to the controller.

7. The system of claim 6, wherein the at least one second event comprises at least one of a concentration of hydrogen decreasing below a threshold value and a concentration of oxygen decreasing below a threshold value, and wherein the controller of the AUV connects the AUV to the hydrogen fuel cell module upon receipt of the signal.

8. The system of claim 1, wherein the instructions further enable the processor to:
receive, from the controller, a signal; and
enable, upon receipt of the signal, the power production in the hydrogen fuel cell module.

9. A system, comprising:
an Autonomous Underwater Vehicle (AUV) comprising a controller and a power source;
a fuel cell module that reacts hydrogen and oxygen to charge the power source; and
a wastewater tank, wherein wastewater from the fuel cell module is collected in a fuel cell module canister and pumped into the wastewater tank.

10. The system of claim 9, wherein the wastewater tank comprises one or more baffles.

11. The system of claim 9, wherein the controller comprises:
a processor; and
a memory coupled with the processor and storing instructions thereon that, when executed by the processor, cause the processor to:
control an operation mode of the fuel cell module.

12. The system of claim 11, wherein the operation mode comprises at least one of a hybrid mode and a load following mode.

13. The system of claim 12, wherein, when in the hybrid mode, the fuel cell module is turned on and off cyclically.

14. The system of claim 13, wherein, when in the load following mode, power output from the fuel cell module is throttled to maintain a charge of the power source at a first charge state.

15. The system of claim 11, wherein the oxygen is fed into a chamber of the fuel cell module, and wherein a concentration of the oxygen in the chamber is about 21%.

16. The system of claim 11, wherein the oxygen is fed directly into a fuel cell of the fuel cell module.

17. The system of claim 11, further comprising:
a heat exchanger, wherein the wastewater interfaces with the heat exchanger before the wastewater is pumped into the wastewater tank.

18. A system, comprising:
an underwater autonomous vehicle (AUV) comprising a controller; and
a hydrogen fuel cell module in electrical communication with the controller of the AUV, the hydrogen fuel cell module comprising:
a processor; and
a memory coupled with the processor and storing instructions thereon that, when executed by the processor, enable the processor to:
monitor power production in the hydrogen fuel cell module;
detect, based on monitoring the power production, at least one event associated with the power production in the hydrogen fuel cell module has occurred;
automatically disable, upon detecting the at least one event, the power production in the hydrogen fuel cell module; and
send, when the power production is disabled, an alert to the controller of the AUV.

19. The system of claim 18, wherein the instructions further enable the processor to:
determine at least one second event associated with the power production in the hydrogen fuel cell module has occurred; and
send, when the at least one second event has occurred, a signal to the controller.

20. The system of claim 19, wherein the at least one second event comprises at least one of a concentration of hydrogen decreasing below a threshold value and a concentration of oxygen decreasing below a threshold value.
